(19) United States
(12) Patent Application Publication
(10) Pub. No.: US 2013/0025698 A1
(43) Pub. Date: Jan. 31, 2013

(54) FUEL-PUMP DRIVE OFF ALERT SYSTEM

(71) Applicants: Behrouz Safi-Samghabadi, Anaheim, CA (US); Tina Safi, Anaheim, CA (US); Nedda Safi, Anaheim, CA (US); Nina Safi, Anaheim, CA (US)

(72) Inventors: Behrouz Safi-Samghabadi, Anaheim, CA (US); Tina Safi, Anaheim, CA (US); Nedda Safi, Anaheim, CA (US); Nina Safi, Anaheim, CA (US)

(21) Appl. No.: 13/354,249

(22) Filed: Jan. 19, 2012

Related U.S. Application Data
(60) Provisional application No. 61/512,414, filed on Jul. 28, 2011.

(51) Int. Cl. F16K 17/40; G08B 21/00

(52) U.S. Cl. 137/68.18; 340/687

(57) ABSTRACT

The present invention consists of a fuel-pump drive off alert system comprising of a fuel pump disengageable device, a disengage detector, a transmitter, and a receiver. In summary, the fuel pump disengageable device comprising of an upper and lower section and the disengage detector comprises of two parts that connect to said upper and lower section of the fuel pump disengageable device. The transmitter is connected to the first part of the disengage detector whereby providing an alert in the form of an alarm or other notification, when the first part and second part of the disengage detector are separated.

This invention claims the benefit of provisional application No. 61/512,414 filed on Jul. 27, 2011, the entire contents of which are hereby incorporated by reference.

### BACKGROUND OF THE INVENTION

(1) Field of the Invention

This embodiment relates to gas station security alerts, and more particularly to a fuel pump drive off alert system that allows gas station employees and/or operators to be alerted when a driver drives off without paying for damage done to a gas nozzle, gas hose and the breakaway units of a fuel pump machine.

(2) Description of Related Art

One can appreciate that gas stations have been around for many years. Initially, gas station employees would be in charge of pumping gas for customers. However, over the years, through the use of technology, it has become common practice for customers to pump their own gas. While customer independence led to more efficiency and convenience for the customer with regards to gas purchase, it presented a new problem to gas station owners which included customers damaging the fuel pump machinery by driving off with the gas nozzle still inside the car. As one can imagine, by doing this, customers can damage many parts of the fuel pump machinery including the fuel nozzle, fuel hose, and/or fuel pump costing the gas station owners thousands in replacement and repair costs.

In attempt to address this situation, a mechanism, called a “breakaway” was created. The breakaway is a cylinder that connects a portion of the hose that is attached to the gas pump to the other portion of the hose that is attached to the nozzle. The purpose of the breakaway is to allow the breakaway to detach in the event that a driver drove off with the fuel nozzle still attached to his/her car and to also seal the portion of the hose attached to the pump to prevent dangerous gasoline and vapors from being released into the environment. Therefore, the breakaway mechanism is well suited to address the issue related to fuel pump damage and the release of gasoline and vapors into the environment when customers drive off with the fuel nozzle/pump still attached to the vehicle. However, the problem still remains of some customers who drive off with the detached fuel nozzle in their car without paying for a replacement nozzle, hose and breakaway, leaving the gas station owner to cover the equipment replacement costs that can be several thousand dollars.

There is currently no system that allows gas station employees or a gas station operator to be alerted when a customer drives off or is about to drive off without paying for damage done to the gas nozzle, gas hose and/or the breakaway parts of the fuel system.

All referenced patents, applications and literature are incorporated herein by reference to their entirety. Furthermore, where a definition or use of a term in a reference, which is incorporated by reference herein, is inconsistent or contrary to the definition of that term provided herein, the definition of that term provided herein applies and the definition of the term in the reference does not apply. The invention may seek to satisfy one or more of the above-mentioned desires. Although the present invention may obviate one or more of the above-mentioned desires, it should be understood that some aspects of the invention might not necessarily obviate them.

### BRIEF SUMMARY OF THE INVENTION

In view of the foregoing disadvantages inherent in the known types of prior art, the general purpose of the present invention, which will be described subsequently in greater detail, is to provide a fuel-pump drive off alert system.

An object of the present invention is to provide a fuel-pump drive off alert system, that will alert the gas station owner/attendant that a driver has or is about to drive off with the fuel nozzle, fuel hose and the breakaway unit attached to the customer's vehicle.

An object of the present invention is to provide a fuel-pump drive off alert system, that will alert the customer that he or she has or is about to drive off with the fuel nozzle, fuel hose and the breakaway unit attached to the his or her vehicle.

Third object of the present invention is to provide a fuel-pump drive off alert system, which reduces or eliminates completely, the costs associated in replacing fuel nozzle, fuel hose and breakaway units due to customer's damage.

Yet another object of the present invention is to provide a fuel-pump drive off alert system, which is cost-effective for gas station operators to use.

Still another object of the present invention is to provide a fuel-pump drive off alert system, which is relatively simple to implement to a new or pre-existing fuel pump system.

Another object of the present invention is to provide a fuel-pump drive off alert system, which allows the disengage detector to be coupled to the disengageable device with or without a clamp.

Further object of the present invention is to provide a fuel-pump drive off alert system, which can become a national and/or local safety requirement that all gas stations implement a fuel-pump drive off alert system.

Still another object of the present invention is to provide a fuel-pump drive off alert system, which can take advantage of modern technology advances like wireless internet to provide the ability to remotely alert the gas station operator of a trigger event.

Another object of the present invention is to provide a fuel-pump drive off alert system which has the ability to record the time when the fuel pump drive off alert system goes off and to also keep a log of all drive off alert events.

To attain this, the present invention consists of a fuel-pump drive off alert system comprising of a fuel pump disengageable device, a disengage detector, a transmitter, and a receiver. In summary, the fuel pump disengageable device comprising of an upper and lower section and the disengage detector comprises of two parts that connect to said upper and lower section of the fuel pump disengageable device. The transmitter is connected to the first part of the disengage detector whereby providing an alert in the form of an alarm or other notification, when the first part and second part of the disengage detector are separated.

There has thus been outlined, rather broadly, the more important features of the invention in order that the detailed description thereof may be better understood, and in order that the present contribution to the art may be better appreciated. There are additional features of the invention that will be described hereinafter.

In this respect, before explaining at least one embodiment of the invention in detail, it is to be understood that the invention is not limited in its application to the details of the construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting. To accomplish the above and related objects, this invention may be embodied in the form illustrated in the accompanying drawings, attention being called to the fact, however, that the drawings are illustrative only, and that changes may be made in the specific construction illustrated.

### BRIEF DESCRIPTION OF THE DRAWING(S)

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1A is a side view of the fuel-pump drive off alert system of the subject matter in accordance with the present invention in an engaged state;

FIG. 1B is a side view of the fuel-pump drive off alert system of the subject matter in accordance with the present invention depicting a breakaway point 125;

FIG. 2 is a top down perspective view of disengage detector of the fuel-pump drive off alert system of the subject matter in accordance with the present invention;

FIG. 3 is a front view of the bracket clamp system of the fuel-pump drive off alert system of the subject matter in accordance with the present invention;

FIG. 4 is a side view of the disengageable device or breakaway piece of the fuel-pump drive off alert system of the subject matter in accordance with the present invention;

FIG. 5 is a perspective view of the fuel-pump drive off alert system of the subject matter in accordance with the present invention depicting the disengage detector being attached to the disengageable device by the bracket clamp system;

FIG. 6 is a perspective view of the fuel-pump drive off alert system of the subject matter in accordance with the present invention depicting an alternate embodiment of the disengage detector being directly attached to the disengageable device without the use of a bracket clamp system;

FIG. 7 is a front exploded view of the fuel-pump drive off alert system of the subject matter in accordance with the present invention depicting an alternate embodiment of the disengage detector with a concave curvature which conforms to the outer curvature of the disengageable device;

FIG. 8 is a perspective view of the fuel-pump drive off alert system of the subject matter in accordance with the present invention depicting an alternate embodiment of the disengageable device containing a plurality of platforms with flat contact surface areas which allow an alternate embodiment of the disengage detector with a flat surface area to attach to said platform;

FIG. 9 is a front exploded view of the fuel-pump drive off alert system of the subject matter in accordance with the present invention depicting an alternate embodiment of the disengageable device containing a plurality of platforms with flat contact surface areas which allow an alternate embodiment of the disengage detector with a flat surface area to attach to said platform.

### DETAILED DESCRIPTION OF THE INVENTION

The invention and its various embodiments can now be better understood by turning to the following detailed description of the preferred embodiments, which are presented as illustrated examples of the invention defined in the claims. It is expressly understood that the invention as defined by the claims may be broader than the illustrated embodiments described below.

Many alterations and modifications may be made by those having ordinary skill in the art without departing from the spirit and scope of the invention. Therefore, it must be understood that the illustrated embodiment has been set forth only for the purposes of example and that it should not be taken as limiting the invention as defined by the following claims. For example, notwithstanding the fact that the elements of a claims are set forth below in a certain combination, it must be expressly understood that the invention includes other combinations of fewer, more or different elements, which are disclosed herein even when not initially claimed in such combinations.

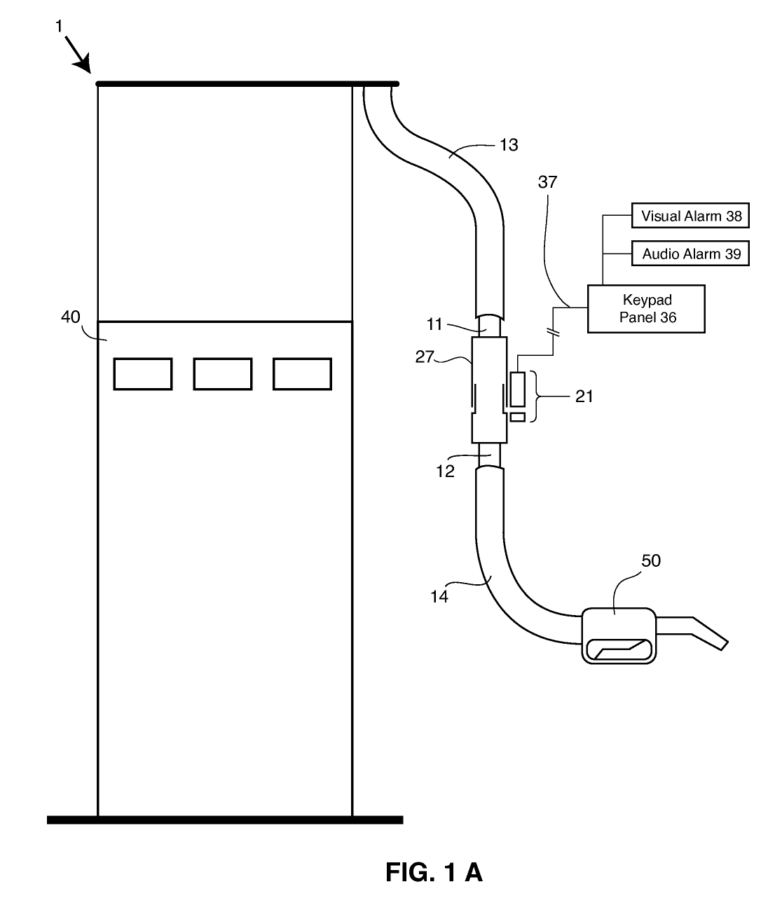

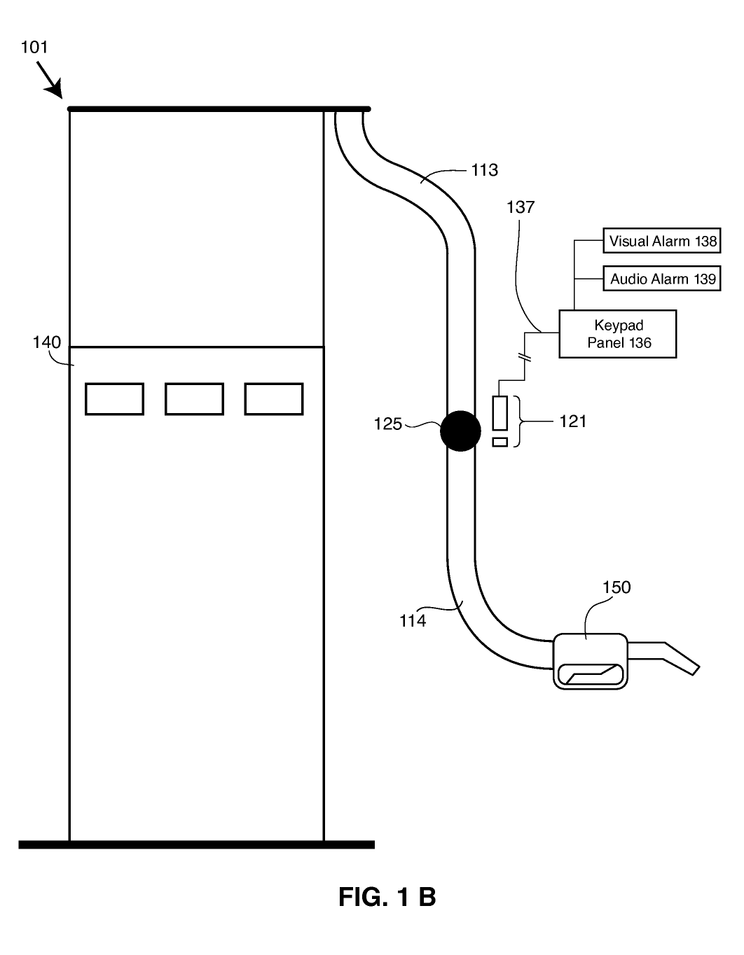

Referring now to the drawings, which are provided by way of illustration and example, and wherein like reference numerals designate like or corresponding elements among the several views, there is shown in FIG. 1A, a fuel-pump drive off alert system 1 comprising of a whip hose 13, a fuel hose 14, a connector to the whip hose 11 and connector to the fuel hose 12, a transmitter such as a disengage detector 21, a disengageable device 27, a receiver such as a keypad panel 36, a signal 37, a visual alarm 38, and an audio alarm 39, a fuel pump 40, and a fuel nozzle 50. FIG. 1A shows one present embodiment of the fuel-pump drive off alert system at its normal position where the disengageable device 27 is engaged and normally connected. The disengageable device 27 can be in the form of a breakaway piece commonly used in the industry. As clearly shown, the transmitter such as the disengage detector 21 is attached to the upper section and lower section of the disengageable device 27. Turning to FIG. 1B, a fuel-pump drive off alert system 101 comprising a fuel pump 140, a whip hose 113, a fuel hose 114, and a fuel nozzle 150 is shown where there is a breakaway point 125 which represents any means used to cause the hose to breakaway at this particular location. In one present embodiment, when a trigger event occurs at the breakaway point 125, the upper part and lower parts of the disengage detector 121 separate to a distance which makes a receiver such as a keypad panel 136 receive a signal from a transmitter (disengage detector 21) wherein said receiver relays the signal to a visual alarm 138 and/or an audio alarm 139 which alerts the gas station operator of the triggering event. In one preferred embodiment of the present invention, the receiver such as the keypad panel 136 has the ability to record the time when a triggering event occurs such as when the upper part and lower parts of the disengage detector 121 are separated which occurs when a driver drives off with the fuel pump still attached to the car. In addition, the receiver such as the keypad panel 136 can maintain a log of all alarm triggering events that occur over a period of time. The disengage detector 21 is attached on the disengageable device 27 proximally attached to the breakaway point 125 of the fuel pump hose.

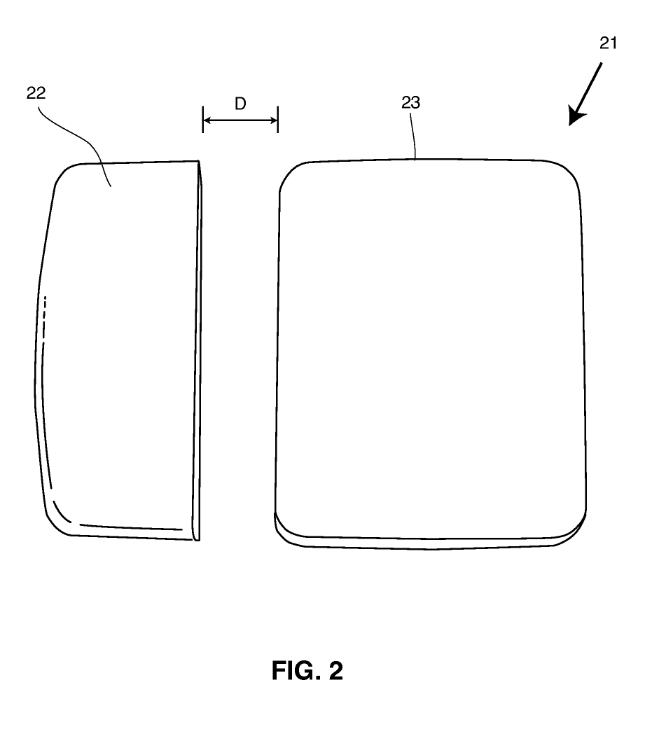

FIG. 2 provides a close up view of one embodiment of the disengage detector 21 comprising a first part 22 and second part 23 of the disengage detector which is attached to the upper and lower portion of the disengageable device 27 (not shown). The letter “D” represents the distance between the first part 22 and second part of the disengage detector 21. In a preferred embodiment, a transmitter such as the disengage detector 21 is connected to the first part 22 of the disengage detector 21 wherein a receiver such as the keypad panel 136 receives a signal from said transmitter. In another preferred embodiment, the first part 22 and second part 23 of the disengage detector 21 may be connected wirelessly through the internet. The transmitter such as the disengage detector may also communicate and send a signal to the receiver, such as a keypad panel, wirelessly through the internet. In one preferred embodiment, the visual alarm and the audio alarm are triggered when the first part 22 of the disengage detector and the second part 23 of the disengage detector can be spaced apart at a range falling in the distance of equal or greater than 1 mm to a distance of equal or greater than 10 mm. However, the distance between the first part 22 of the disengage detector 21 and second part 23 of the disengage detector 21 which triggers either the video alarm and/or audio alarm can be any distance range desired by the operator depending on preference. For example, another embodiment may provide that the video and/or audio alarm will be triggered immediately upon any separation of the first part 22 and second part 23 of the disengage detector 21.

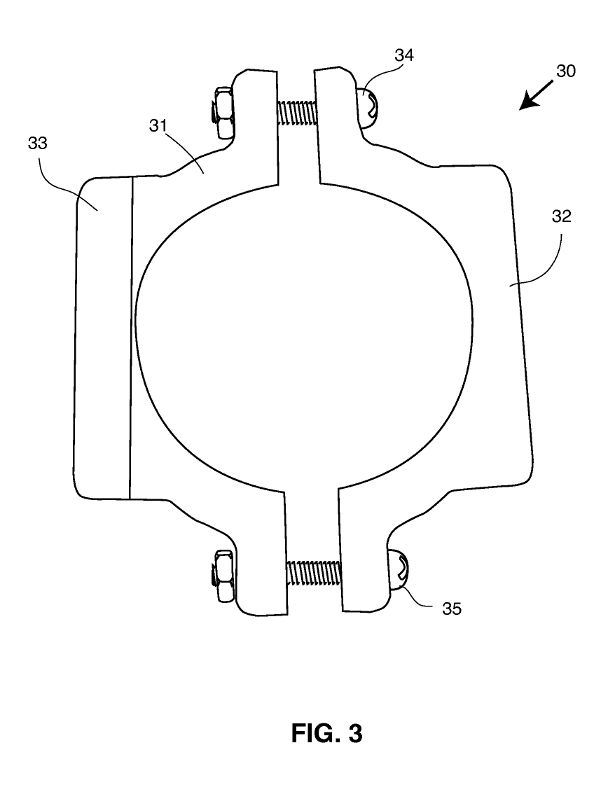

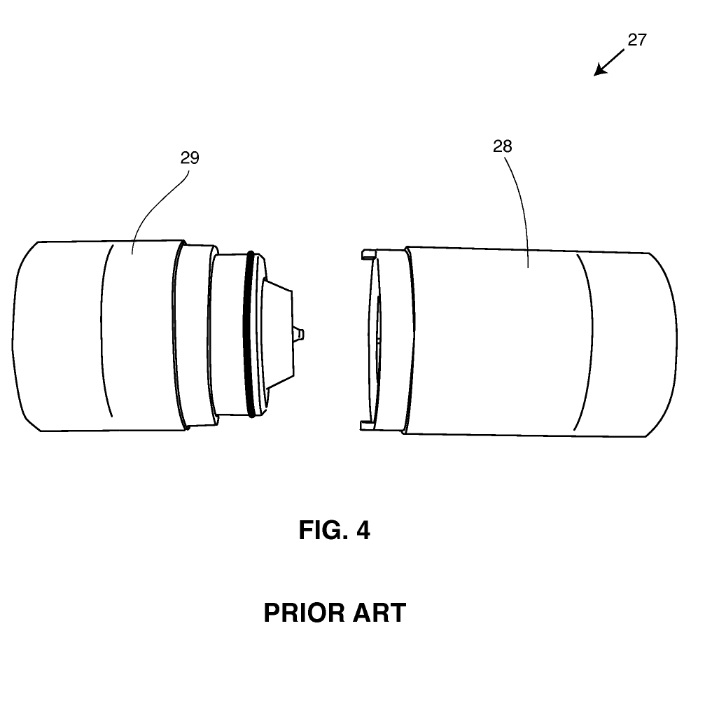

As seen in FIG. 3, a bracket system 30 is shown. In one present embodiment, the bracket system 30 can be a clamp and is comprised of a first bracket piece 31, a second bracket piece 32, and an attachment piece 33 which can be in the form of adhesive or double-sided foam adhesive tapes. The bracket system 30, also comprising of a first screw 34 and a second screw 35. FIG. 4 depicts the prior art breakaway device 27 having an upper portion 28 and lower portion 29 as common in the industry.

FIG. 5 shows a preferred embodiment wherein the bracket system 30 allows the first part 22 and second part 23 of the disengage detector 21 to be securely coupled to the upper portion 28 and lower portion 29 of the disengageable device 27. The first part 22 and second part 23 of the disengage detector 21 can be mounted to the bracket system 30 by the attachment piece 33 and the first bracket piece 31 and second bracket piece 32 allow the attachment piece 33 of the bracket system 30 to be securely attached to the upper portion 28 and lower portion 29 of the disengageable device.

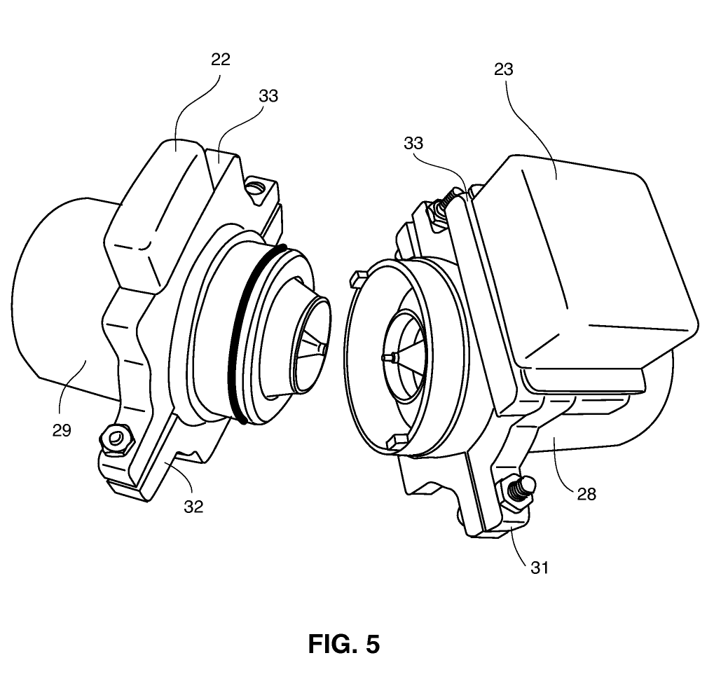

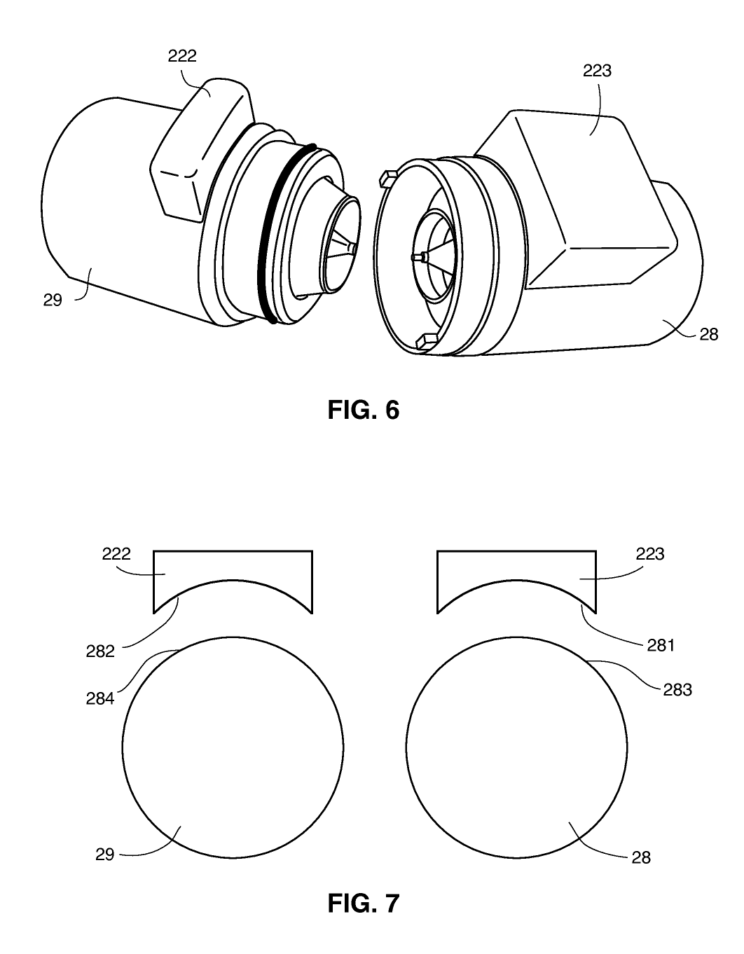

One can appreciate that there exists a plurality of different ways to attach the disengage detector to the disengageable device. Turning to FIG. 6 depicts an alternate embodiment of the first part of the disengage detector 222 and second part of the disengage detector 223 being connected to the disengageable device without using a clamp. As seen in FIG. 7, the first part of the disengage detector 222 contains a curved bottom 282 and the second part of the disengage detector 223 having a curved bottom 281, which allows both to conform and connect to the outer curvature of the outer surface of the disengageable device. In one present embodiment, the curved bottoms 282 and 283 may be connected to the disengageable device via at least one member selected from the group consisting of adhesives, double-sided adhesive tape and screw.

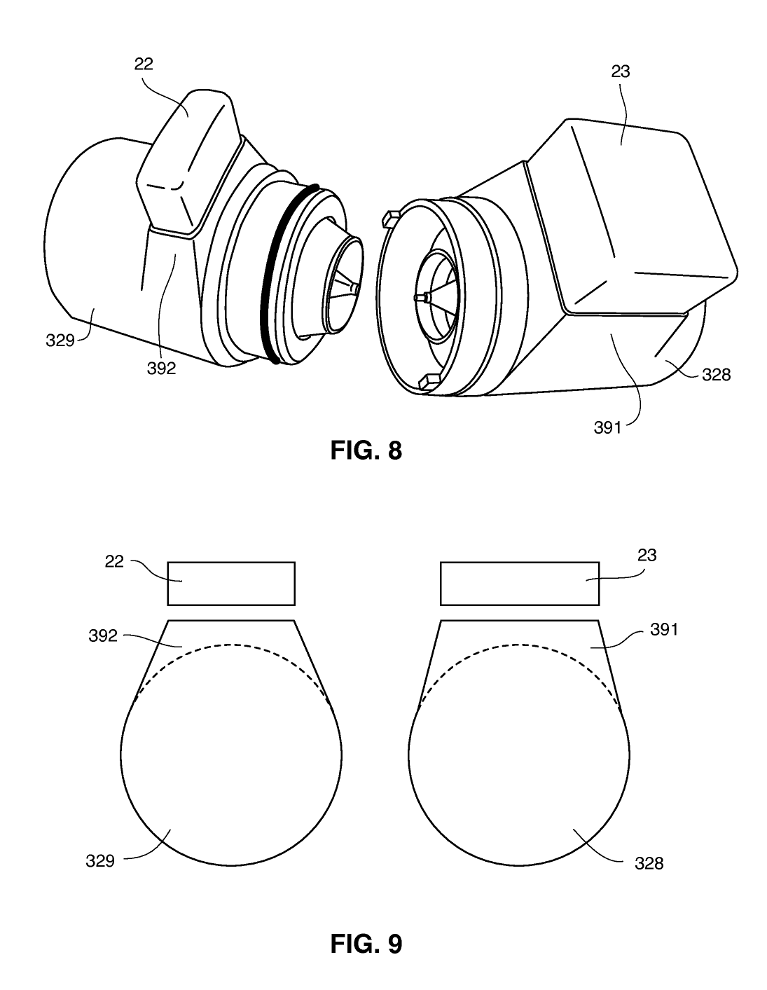

FIG. 8 shows yet another alternate embodiment wherein the lower portion 329 of the disengageable device and upper portion 328 contain raised platforms, 391 & 392 respectively, which are adaptors having a flat contact surface. As seen in FIG. 9, one raised platform adaptor 392 is coupled to the lower portion 329 of the disengageable device and the other platform adaptor 391 is coupled to the upper portion 328 of the disengageable device. The flat contact surface areas of both raised platforms allow the first part 22 and second part 23 of the disengage detector to attach to the upper portion 328 and lower portion 329 of the disengageable device without the need of a clamp. In one present embodiment, first part 22 and second part 23 may be connected to the raised platforms, 391 & 392 respectively, of the disengageable device via at least one member selected from the group consisting of adhesives, double-sided adhesive tape and screw. Yet another embodiment the raised platforms 391 and 392 are adaptors, separable from a prior art breakaway device. Still another embodiment, the raised platforms 391 and 392 are integral part of the prior art breakaway device. In another embodiment, the raised platforms 391 and 392, detectors 22 and 23, all are integral part of the prior art breakaway device.

In another preferred embodiment, a method of alerting a fuel pump drive-off is also provided comprising installing a disengage detector on a disengageable device of a hose of a fuel pump, wherein the disengage detector having a first part and a second part, wherein the disengageable device having a upper section and a lower section, wherein the upper section is connected to a whip hose and the lower section is connected to a fuel hose, wherein the whip hose is connected to the fuel pump and the fuel hose is connected to a nozzle; installing a transmitter on the first part of the disengage detector; installing a remote receiver for receiving signals from the transmitter; and sending alerts from the transmitter to the remote receiver when a driver pulls the nozzle from the fuel pump causing the first part and the second part of the disengage detector to be spaced apart for equal or more than 1 mm.

Thus, specific embodiments and applications of the have been disclosed. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components or steps may be present, or utilized, or combined with other elements, components, or steps that are not expressly referenced. Where the specification claims refer to at least one of something selected from the group consisting of A, B, C . . . and N, the text should be interpreted as requiring only one element from the group, not A plus N, or B plus N, etc.

What is claimed is:

1. A fuel pump drive-off alert system comprising:
a fuel pump disengageable device having a upper section and a lower section;
a disengage detector having a first part and a second part, wherein the first part and the second part of the disengage detector are coupled to said upper section and said lower section, respectively;
a transmitter, wherein the transmitter is connected to the first part of the disengage detector; and
a receiver, wherein the receiver receives signals from the transmitter.

2. The system of claim 1, wherein the first part and the second part of the disengage detector are mounted to a surface of a plurality of clamps and the clamps are attached on the disengageable device.

3. The system of claim 2, wherein the disengage detector is mounted on the surface of the clamps by an adhesive or double-sided foam adhesive tapes.

4. The system of claim 1, wherein the first part of the disengage detector and the second part of the disengage detector are connected wirelessly.

5. The system of claim 1, wherein the receiver is a keypad panel.

6. The system of claim 1, wherein the receiver receives signals from the transmitter and relays the signals to a visual alarm and an audio alarm.

7. The system of claim 1, wherein the fuel pump disengagable device is a breakaway mechanism.

8. The system of claim 6, wherein the visual alarm and the audio alarm are triggered when the first part of the disengage detector and the second part of the disengage detector are spaced apart at a distance of equal or greater than 3 mm.

9. The system of claim 1, wherein the first part and second part are directly connected to the upper section and the lower section without using a clamp, and is connected via at least one member selected from the group consisting of adhesives, double-sided adhesive tape, and screw.

10. The system of claim 9, wherein the first part has a first contact surface, wherein the upper portion has an outer surface to make engaging contact with said first contact surface; wherein the first contact surface has a concave curvature to conform to an outer curvature of the outer surface.

11. The system of claim 9, wherein the first part has a first contact surface, wherein the upper portion has an outer surface to make engaging contact with said first contact surface; wherein the first contact surface is flat, to conform to an flat side of the outer surface.

12. The system of claim 1, wherein the first part is an integral part of said upper portion, and the second part is an integral part of said lower portion.

13. The receiver such as the keypad panel in claim 5 having the ability to record the time that an alarm is triggered and keeping a log of all alarm events.

14. A fuel dispenser with alerting system comprising:
a fuel pump;
a fuel pump hose having a breakaway point dividing the fuel pump hose into a upper section and a lower section, wherein the upper section is connected to a whip hose and the lower section is connected to a fuel hose;
a disengage detector having a first part and a second part, wherein the first part and the second part of the disengage detector are coupled to the upper section and the lower section, respectively;
a transmitter, wherein the transmitter is connected to the first part of the disengage detector;
a receiver, wherein the receiver receives signals from the transmitter; and
a nozzle,
wherein the whip hose is connected to the fuel pump and the fuel hose is connected to the nozzle.

15. The system of claim 14, wherein the first part and the second part of the disengage detector are mounted to a surface of a plurality of brackets and the brackets are attached to proximally to the breakaway point of the fuel pump hose.

16. The apparatus of claim 15, wherein the disengage detector is mounted on the surface of the brackets by adhesives or double-sided adhesive tapes.

17. The system of claim 14, wherein the first part of the disengage detector can wirelessly sense whether or not the second part of the disengage detector is within a threshold distance from said first part.

18. The system of claim 14, wherein the receiver is a keypad panel.

19. The system of claim 14, wherein the receiver receives signals from the transmitter and relays the signals to at least one of a visual alarm and an audio alarm.

20. The system of claim 19, wherein the visual alarm and the audio alarm are triggered when the first part of the disengage detector and the second part of the disengage detector are spaced apart at a distance of equal or greater than 7 mm.

21. The system of claim 14, wherein the breakaway point is a breakaway mechanism having an upper section and a lower section.

22. The system of claim 21, wherein the disengage detector is attached on the breakaway mechanism.

23. A method of alerting a fuel pump drive-off comprising:
installing a disengage detector on a breakaway mechanism of a hose of a fuel pump,
wherein the disengage detector having a first part and a second part,
wherein the breakaway mechanism having a upper section and a lower section, wherein the upper section is connected to a whip hose and the lower section is connected to a fuel hose,
wherein the whip hose is connected to the fuel pump and the fuel hose is connected to a nozzle;
installing a transmitter on the first part of the disengage detector;
installing a remote receiver for receiving signals from the transmitter; and
sending a signal from the transmitter to the remote receiver when the first part and the second part of the disengage detector to be spaced apart for equal or more than 1 mm.

24. The method of claim 23, wherein the signal is sent from the transmitter to the remote receiver when the first part and the second part of the disengage detector are spaced apart for equal or more than 3 mm.

25. The method of claim 24, wherein the signal is sent from the transmitter to the remote receiver when the first part and the second part of the disengage detector are spaced apart for equal or more than 10 mm.
